(19) United States
(12) Patent Application Publication
(10) Pub. No.: US 2002/0141442 A1
(43) Pub. Date: Oct. 3, 2002

(54) Method and apparatus for providing network access for PDA devices

(75) Inventors: David Watt Plain, East Lothian (GB); George Keith Manning, West Lothian (GB)

Correspondence Address: MICHAELSON AND WALLACE, PARKWAY 109 OFFICE CENTER, 328 NEWMAN SPRINGS RD, P O BOX 8489, RED BANK, NJ, 07701

(73) Assignee: 3Com Corporation

(21) Appl. No.: 09/862,352

(22) Filed: May 22, 2001

(30) Foreign Application Priority Data
Apr. 3, 2001 (GB) 0108333.6

(51) Int. Cl. H04L 12/66

(52) U.S. Cl. 370/466; 370/352; 370/338

(57) ABSTRACT

A method and apparatus for communicating data from a Personal Digital Assistant (PDA) device over a network is described. In a preferred embodiment, the data is received from the PDA device by a network device through a short-range wireless interface. The network device determines the format of the received data and converts it to a data packet format suitable for transmission across the network.

### BACKGROUND OF THE INVENTION

1. Field of the Invention

The present invention relates generally to data communications networks, and more specifically to a method and apparatus for providing access to such networks by Personal Digital Assistant devices (hereinafter referred to as “PDA devices”).

2. Description of the Related Art

Data communications networks are being used more and more for communications in the business environment. Such networks comprise a plurality of “network devices” including computers, peripherals and other electronic devices capable of communicating with each other by sending and receiving data packets in accordance with predefined network protocols. Except in the case of wireless networks, each network device is connected to the network media, which in the case of a LAN (Local Area Network) or WAN (Wide Area Network) may be coaxial cable, twisted pair cable or fibre optic cable. A network is generally configured with core network devices having a plurality of ports, which can be used to interconnect a plurality of media links on the network. Such devices, which include hubs, switches and routers, pass data packets received at one port to one or more of its other ports, depending upon the type of device.

The TCP/IP group of protocols is commonly used in most modern networks to allow data to be communicated across the Internet. Data packets formatted according to these group of protocols contain address information in the header of each data packet, namely the IP address of the source network device and the IP address of the destination network device, in order to enable routing of the data packets across the network.

In addition to data communication, businesses are increasingly using their LAN and WAN networks for telecommunications. The ability to communicate voice, as well as data, across networks by IP telephone devices using the Voice-over Internet Protocol (VoIP) has enabled the convergence of telecommunication and data communication networks.

In addition to the increasing use of the resources provided by networks, PDA devices are widely used by individuals in the course of their business. PDA devices are small portable devices which store information such as address book and calendar information for use by the individual. PDA devices typically use unique protocols, particular to the PDA vendor. However, PDA data can be downloaded from a PDA device to a personal computer for back-up purposes. In addition, some PDA devices have an IrDA (Infrared Data Association) interface which enables exchange of data from PDA to PDA over a relatively short distance (about 1 meter). Such PDA devices include the PalmPilot available from Palm, Inc. of Santa Clara, USA. Data is exchanged between two such PDA devices using an appropriate PDA data format or protocol, which is recognised by, and compatible with, the software application running on the PDA.

It would therefore be desirable to make more effective use of PDA devices, and in particular improve the range across which data can be communicated from and to PDA devices.

### SUMMARY OF THE INVENTION

In accordance with a first aspect, the present invention provides a method for communicating data from or to a Personal Digital Assistant (PDA) device over a network, the method comprising: receiving data from a PDA device in a PDA format, and converting the received data to a format suitable for transmission across the network.

Preferably, the method includes the step of determining the format of the received data and converting the data accordingly.

Thus, the present invention provides the ability to communicate data from a PDA device across a network to a network device. In addition, in a preferred embodiment, the method enables the data transmitted across the network to be received at a network device and transmitted to another PDA device.

In a preferred embodiment, the present invention is implemented in a network device and utilises hardware, in the form of a wireless interface (e.g. implementing IrDA protocol or Bluetooth) to receive data from and transmit data to a PDA device. In addition, the preferred embodiment of the present invention utilises software in which data received from a PDA in a relevant PDA protocol is converted to an appropriate network protocol, for example IP (Internet Protocol) for TCP/IP networks. The converted data may then be passed across the network to another network device.

In accordance with a second aspect, the present invention provides a method for communicating data to a Personal Digital Assistant (PDA) device from a network, the method comprising: receiving data from the network in a network compatible format, and converting the received data to a PDA format suitable for transmission to a PDA device.

In accordance with a third aspect, the present invention provides a computer program for carrying out the method in accordance with the first and/or second aspect of the present invention.

In accordance with a fourth aspect, the present invention provides a network device configured to receive data from a PDA device in a PDA format using a short range wireless link, and configured to convert the received data to a format suitable for transmission across a network.

Other preferred and optional features of the present invention will be apparent from the following description and accompanying claims.

### BRIEF DESCRIPTION OF THE DRAWINGS

Embodiments of the present invention will now be described, by way of example, with reference to the accompanying drawings, in which:

FIG. 1 schematically illustrates the use of the present invention for communicating data from a PDA device to another PDA device across a network, and

FIG. 2 is a flow diagram showing the method steps performed in communicating the data between the PDA devices illustrated in FIG. 1.

### DESCRIPTION OF THE PREFERRED EMBODIMENTS

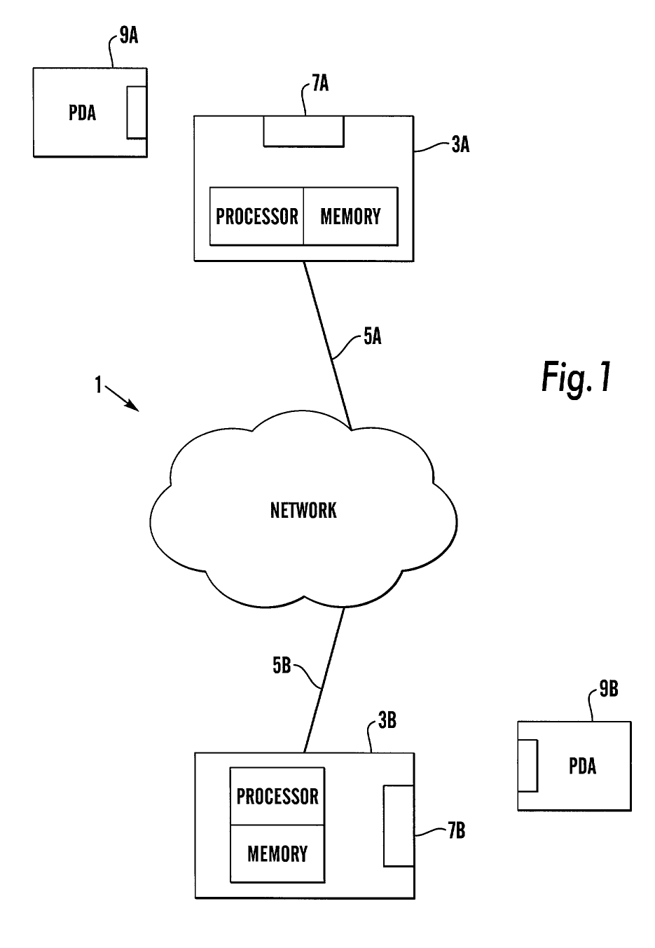

FIG. 1 illustrates a first network device 3A forming a fixed node on a network 1. The network device 3A may be a LAN telephone device or laptop device capable of sending and receiving data and voice communications on the network 1 using, for example, TCP/IP protocols including the IEEE 802.2 Link Layer protocol. In the following description, the network 1 utilises TCP/IP (OSI layer 3) protocols. The skilled person will appreciate that the present invention may also be implemented in networks which send voice communications using Ethernet (OSI layer 2) protocols, or proprietary protocols.

Network device 3A thus includes conventional hardware in the form of a processor and memory, and software applications for handling data and voice communication.

In addition, in accordance with the present invention, the network device 3A includes a wireless interface 7A for sending and receiving wireless data communications. The wireless interface 7A may implement the IrDA protocol, Bluetooth or other relatively short-range wireless protocols implemented for communication with PDA devices.

A first PDA device 9A, having a wireless interface compatible with the wireless interface 7A of network device 3A includes memory storing data in PDA format.

In the present example, an individual wishes to communicate data from his PDA device 9A to the PDA device 9B of a second individual at a remote location from the first individual.

In accordance with the present invention, the network device 3A may be used as a network access point by the individual wishing to communicate the data from the PDA device 9A. The second individual wishing to receive the data in his PDA device 9B can similarly use a second network device 3B, similar to the network device 3A, which is connected to the network by media link 5B.

In particular, the first individual operates the PDA device 9A to transmit the PDA data from PDA device 9A to the network device 3A. The network device 3A receives the PDA data at wireless interface 7A, determines the PDA format and converts the data to network data packets. The network data packets are then passed over the network 1 to the second network device 3B. The second network device 3B may then operate to convert the network data packets back to PDA packets which can be sent from the wireless interface 7B of network device 3B to the second PDA device 9B, remote from the first PDA device 9A.

Thus, data can be transferred between PDA devices across large distances through use of the infrastructure of the network. Existing PDA wireless interfaces can be utilized. There is no need to change or adapt the PDA devices in order to enable the transfer of data.

Whilst in the preferred embodiment illustrated in FIG. 1, interface 7A is a wireless interface, the skilled person will appreciate that a serial port interface may be utilised in accordance with the present invention. In particular, a relatively short range, serial connection may be utilised between first or second network device 3 and first or second PDA device 9, respectively.

Furthermore, the skilled person will appreciate that the configuration does not need to be symmetric, as illustrated. Rather, the first and second PDA devices may be different types of PDA devices, and the interfaces used to connect the first PDA device and the first network device, may be different from the interfaces used to connect the second PDA device and the second network device.

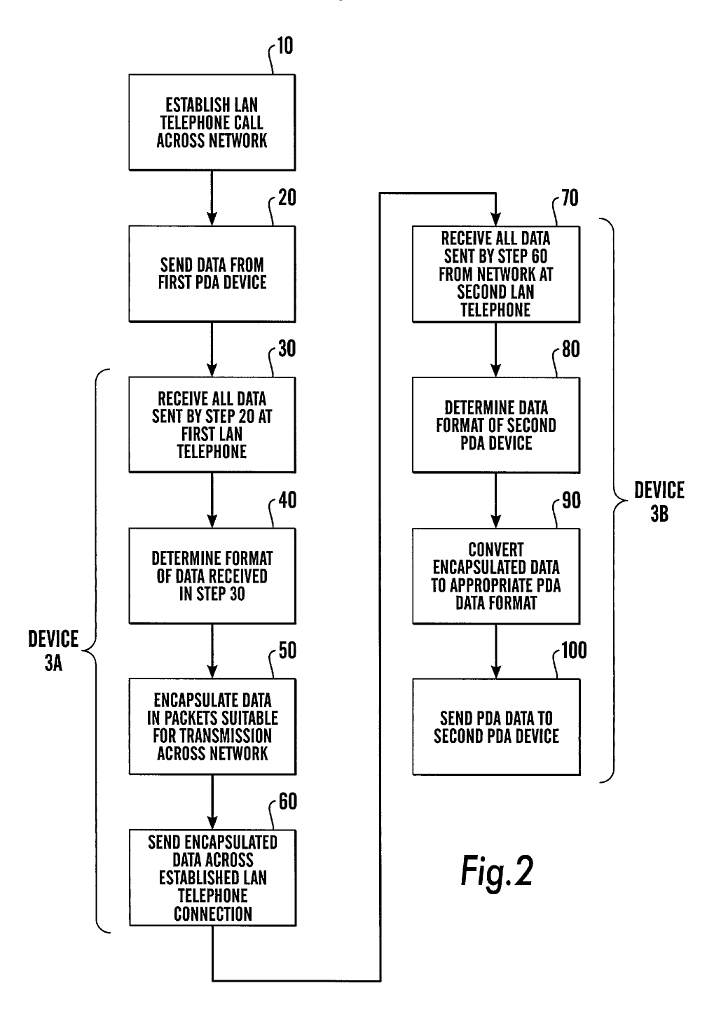

In accordance with a preferred embodiment, and as described below with reference to FIG. 2, the network devices 3A and 3B are LAN telephone devices.

FIG. 2 shows the method steps employed in the system shown in FIG. 1 to transfer data from PDA device 9A to PDA device 9B.

In accordance with the preferred embodiment, the present invention is implemented by software running on telephone network devices 3A and 3B shown in FIG. 1. It will be appreciated that the method of the present invention may be implemented in other forms, such as hardware.

Referring to FIG. 2, at step 10 a telephone call is first established between the first individual using telephone device 3A and the second individual using telephone device 3B across the network 1. As is well known in the art of LAN telephony, the establishment of a telephone call provides a (temporary dedicated) connection between the two telephone devices, enabling voice data packets to be exchanged without explicit addressing information, once the connection or “conduit” has been established. In accordance with the preferred embodiment, TCP/IP protocol data packets (e.g. VoIP data packets) are exchanged during the telephone conversation. In other embodiments, Ethernet data packets may be exchanged.

During the conversation, the first individual, using telephone device 3A, suggests to the second individual, using telephone device 3B, that he send certain data from his PDA device 9A to the PDA device 9B of the other individual for use. For example, the data may include directions and/or a map; contact information of mutual interest or other relevant PDA information.

Thus, at step 20, the first individual operates his PDA device 9A which transmits the selected PDA data from PDA device 9A to telephone device 3A using their respective wireless interfaces. In the preferred embodiment, the wireless interfaces are IrDA interfaces which are conventionally implemented in PDA devices such as the PalmPilot and used to link to IrDA telephone devices for speed-dial purposes using the PDA address book. The use of the existing IrDA interfaces is accordingly advantageous.

At step 30, the telephone device 3A receives the selected PDA data through the wireless interface 7A. Importantly, in the preferred embodiment, all the selected data is gathered by the telephone device 3A, before proceeding to the subsequent steps of sending data across the network 1, as described below. This ensures that if the PDA device 9A terminates the transmission of the PDA data to the telephone device 3A, which may arise if the wireless interface connection is lost, no data will be transmitted across the network 1.

At step 40, the telephone device 3A determines the format of the PDA data.

At step 50 the telephone device 3A converts the PDA data to an appropriate network protocol for communication across the network 1. More specifically, step 50 encapsulates the PDA data received at step 30 in data packets of suitable format for transmission across the network 1. In the preferred embodiment, the PDA data is encapsulated in IP data packets for transmission across the network 1. The skilled person will appreciate that the encapsulated data packets may be implemented in any network protocol which can identify the encapsulated data as PDA data. However, the preferred embodiment utilises IP, since the telephone device 3A includes an IP stack for sending IP voice packets on the network.

At step 60, the encapsulated data packets from step 50 are sent from telephone device 3A to telephone device 3B across the established connection. In particular, the data is sent as additional packets along with the existing voice packets of the telephone conversation. Advantageously, no additional addressing information is required in order to convey the data from telephone device 3A to telephone device 3B, since the call has been established at step 10.

It will be appreciated from the above that steps 30 to 60 are carried out in software running on telephone device 3A. The subsequent steps concerning the receipt of the data are carried out by software running on telephone device 3B, as will be appreciated from the following.

At step 70, the telephone device 3B receives all the data packets, sent in step 60, from the network 1.

The second individual (the recipient) now wishes to transfer the data to his PDA device 9B. In order to achieve this, he needs to operate the network device 3B to convert the network data packets (e.g. data packets in IP format) to data compatible with PDA device 9B.

Thus, at step 80, the data format used by the second PDA device is determined. The PDA data format can be determined in a number of ways. For example, the network device 3B upon receipt of the data at step 70 may send out a test transmission from its wireless interface 7B. The PDA device 9B may then respond with the relevant protocol information.

Thus, at step 90 the network device 3B converts the received network data packets to data in the appropriate PDA format.

At step 100, the network device transmits the resulting PDA data through wireless interface 7B to the second PDA device 9B.

The second individual can then access the PDA information using his PDA device 9B.

It will be appreciated that the software running on telephone device 3B may be configured to perform steps 90 and 100 automatically upon receipt of relevant network data packets, by pre-specifying the PDA protocol of the PDA device 9B. The user then need only ensure that the wireless interface of his PDA device is within the necessary physical range for communication of the data from the telephone device 3B to the PDA device 9B.

Moreover, whilst steps 20 and 30, and steps 90 and 100 are preferably performed in response to user activation, it will be appreciated that such steps could be performed automatically.

In addition to enable the transfer of PDA data from one PDA device to another PDA device over a network, the present invention may be employed to provide a PDA device with access to a network for other purposes. For example, the PDA device 9A may use a network device 3A as an access point for browsing the internet or sending and retrieving email in a similar manner to modem dial-up interfaces currently in use and well known in the art. In particular, the PDA device may run a Web Browser, and would send data to, and receive data from, the network device 3A using a relevant PDA format, for example, IP data packets in PPP (Point-to-Point Protocol) encapsulating HTML data. In accordance with the present invention, the network device 3A would convert the IP data packets, exchanged during internet browsing, between the appropriate Link Layer protocols (e.g. IEEE 802.2 and Bluetooth/IrDA/Serial RS232).

In an alternative embodiment, the network devices 3A and 3B of FIG. 1 are not telephone devices. In this case, a point-to-point connection cannot be utilized through the establishment of an IP telephone call. Accordingly, in such an embodiment, it would be necessary to register the PDA devices 9A and 9B with a server using an appropriate registration protocol. The server would register an identifier of the PDA device (e.g. a name/address) together with the network location/address at which the PDA device could send and receive information across the network (e.g. the IP address of a particular telephone device). Thus, the server would hold a directory of PDA devices and corresponding network devices.

For this alternative embodiment, the SIP protocol would be one suitable method by which registration of PDA devices could be achieved using a SIP server. A SIP application on the PDA device, or a SIP proxy on the corresponding network device, configured with the address of the SIP server and permission to register with it, would be necessary. Communications destined for a PDA device, and utilising the SIP protocol, could then be directed to the network device registered for the PDA device by the SIP server.

Whilst the described embodiment is implemented in a TCP/IP LAN networks, it will be appreciated that it may be implemented in other networks, for example, networks employing protocols such as IPX or AppleTalk.

As the skilled person will appreciate, various modifications and changes may be made to the described embodiments. It is intended to include all such variations, modifications and equivalents which fall within the spirit and scope of the present invention, as defined in the accompanying claims.

1. A method for communicating data from a Personal Digital Assistant (PDA) device over a network, the method comprising: receiving data from a PDA device in a PDA format, and converting the received data to a format suitable for transmission across the network.

2. A method as claimed in claim 1, wherein the data is received by a network device through an interface selected from the group consisting of a wireless interface and a serial interface.

3. A method as claimed in claim 1, further comprising, after the step of receiving, determining the format of the received data, and converting the data accordingly.

4. A method as claimed in claim 1, wherein the network is a LAN network, and the step of converting comprises encapsulating the data in data packets in accordance with the LAN protocols.

5. A method as claimed in claim 1, further comprising: transmitting the converted data from a first network device to a second network device across the network.

6. A method as claimed in claim 5, further comprising receiving the converted data at the second network device, and converting the data to a format suitable for transmission to a second PDA device.

7. A method as claimed in claim 6, further comprising, prior to the step of converting, determining the data format used by said second PDA device.

8. A method as claimed in claim 6, the second network device further transmitting the data to a second PDA device through an interface selected from the group consisting of a wireless interface and a serial interface.

9. A method as claimed in claim 1, wherein, prior to the step of receiving, a telephone connection is established between at least two telephone devices on the network, and wherein the step of receiving data comprises receiving data at one of the telephone devices through an interface selected from the group consisting of a wireless interface and a serial interface.

10. A method as claimed in claim 9, further comprising: transmitting the converted data from said one of the telephone devices to the other of the telephone devices across the established network connection.

11. A method for communicating data to a Personal Digital Assistant (PDA) device from a network, the method comprising: receiving data from the network in a network compatible format, and, and converting the received data to a PDA format suitable for transmission to a PDA device.

12. A method as claimed in claim 11, further comprising transmitting the data from a network device to a PDA device through a wireless interface.

13. A computer readable medium including a computer program for carrying out the method as defined in claim 1.

14. A computer readable medium including a computer program for communicating data from a Personal Digital Assistant (PDA) device over a network, the program comprising: a program step for receiving data from a PDA device in a PDA format, and a program step for converting the received data to a format suitable for transmission across the network.

15. A network device configured to receive data from a PDA device in a PDA format using a short range wireless link, and configured to convert the received data to a format suitable for transmission across a network.

16. A network device as claimed in claim 15, wherein the PDA device is further configured to determine the format of the received data, and to convert the data accordingly.
